(19) United States
(12) Patent Application Publication
(10) Pub. No.: US 2019/0195585 A1
(43) Pub. Date: Jun. 27, 2019

(54) SMART GUN

(71) Applicant: Kim Rensing, Trenton, IL (US)

(72) Inventor: Kim Rensing, Trenton, IL (US)

(21) Appl. No.: 16/228,913

(22) Filed: Dec. 21, 2018

Related U.S. Application Data
(60) Provisional application No. 62/608,823, filed on Dec. 21, 2017.

(51) Int. Cl. F41A 17/06; G01S 19/13; F41A 3/66; H04N 7/18; H04R 1/02

(52) U.S. Cl. CPC F41A 17/063; G01S 19/13; H04W 4/80; H04N 7/185; H04R 1/028; F41A 3/66

(57) ABSTRACT

A firearm (F) for use by a police officer includes a frame (E). A video camera (CAM) is attached to an underside of the frame at the muzzle end of the weapon. A microphone (MIC) is also mounted to the frame. A transmitter (XMT) and receiver (RCV) are mounted on the frame and transmit video imagery and receive audio communications so the police officer carrying the firearm is in two-way communications with remote locations. These components are activated when the officer draws the firearm and moves a safety switch (S) on it from an “off/safe” to an “on/fire” position. A GPS mounted in the frame provides the location of the firearm. All of these components are supplied power by a battery (B) installed in the frame and charged by a battery charger (BC) when the firearm is holstered in a holster (L).

### REFERENCE TO RELATED APPLICATIONS

This application is based on, and claims the benefit of, U.S. provisional patent application 62/608,823 filed Dec. 21, 2017, the contents of which are incorporated herein by reference.

### BACKGROUND OF THE INVENTION

This invention relates to firearms; and, more particularly, a “smart” gun having a variety of capabilities which provide police and other law officers significant advantages when dealing with volatile situations.

With advances in modern technology, numerous features which were previously unavailable to firearm manufacturers are now available. These new features are particularly relevant when it comes to weaponry used by law enforcement personnel. The incorporation of these features particularly into the sidearms carried by police, and others, not only make them better able to carry out their duties, but also help in keeping them safe while doing so. The new technology makes it easier to determine an officer's exact location at all times, allows the officer to directly communicate with his partner manning a squad car or with a police dispatcher; and, in real time, enable the recordation and transmittal of actions occurring whenever the officer has to draw his weapon and ready it for use.

Most police officers now carry automatic handguns rather than pistols. Accordingly, it would be helpful to incorporate the technology now available into such weapons so they can be carried by police officers while serving in the line of duty.

### BRIEF SUMMARY OF THE INVENTION

The present disclosure is directed to a firearm in which is integrated numerous features, now available because of advances in technology, useful to policemen and other law enforcement persons to enable them to better protect those whom they serve. The technology now incorporated in a firearm of the present invention includes a global positioning system (GPS) that enables an officer's exact location to be known at all times while on duty. Next, the weapon includes a transmitter and receiver that allows the officer to directly communicate with his partner manning a squad car, or with other officers in the area, or with a police dispatcher, all in real time. This is especially important in dangerous situations which have required the officer to draw his weapon. Further, the advanced firearm of the present invention also includes a camera to enable real time recordation and transmittal of events occurring at the location where the officer has had to draw his weapon and ready it for use.

Other objects and features will be in part apparent and in part pointed out hereinafter.

### BRIEF DESCRIPTION OF THE SEVERAL VIEWS OF THE DRAWINGS

The accompanying figure, together with detailed description which follows, form part of the specification and illustrate the various embodiments described in the specification.

FIG. 1 illustrates a firearm for use by law enforcement personnel and having communications, incident recording, and officer location capabilities between the officer holding the weapon and others; and,

FIG. 2 illustrates a holster for the firearm including a battery charger for keeping a battery housed in the firearm charged.

### DETAILED DESCRIPTION OF INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

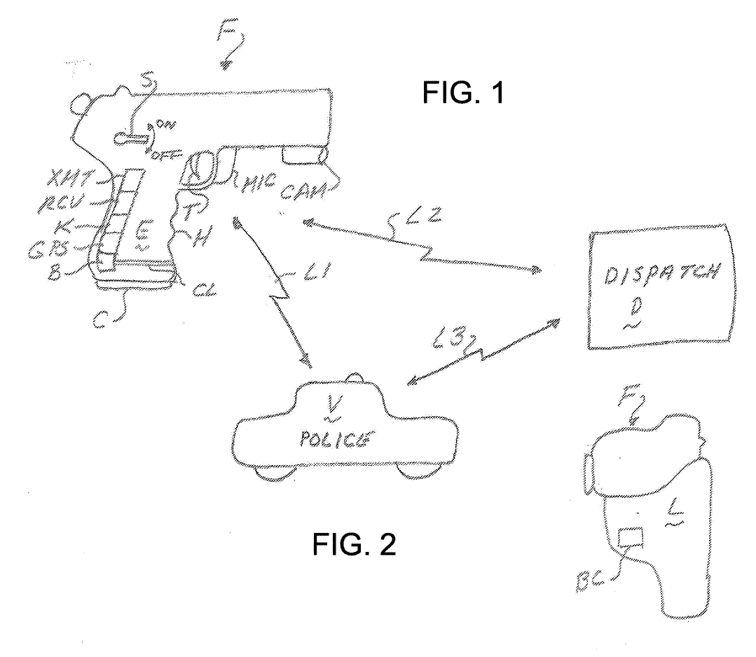

Referring to FIG. 1, a firearm of the present invention is indicated generally F. Firearm F is, for example, a sidearm carried by a policeman or other law enforcement official. Typically, when the firearm is holstered, a safety switch S on the side of the weapon is set to an “off.” or “safety” position meaning that the weapon will not discharge if one were to attempt to pull the weapon's trigger. If weapon F is an automatic firearm, ammunition for the weapon is loaded into a clip C which is inserted into the firearm through a slot (not shown) in the base of the weapon's handle H. Those skilled in the art understand that, if circumstances warrant, the police officer places his hand on handle or grip H to withdraw the weapon from its holster L, see FIG. 2, to aim or point the weapon at a target. Those skilled in the art further understand that if the firearm is a revolver, the weapon's ammunition is loaded into chambers in a cylinder that revolves when the officer cocks a trigger to bring a round of ammunition into a position to be fired when the trigger is pulled.

Almost all of the time an officer is on duty, firearm F remains holstered in its holster L with safety switch S in its “off/safe” position. Only in rare instances will an officer feel that a situation is so potentially dangerous that he needs to un-holster his weapon; and, even then, in most instances he will leave the weapon's safety “off/safe” position. If, however, the officer releases safety switch S so that the safety switch is moved from “off/safety” to “on/fire”, the officer is then able to discharge the weapon by pulling on its trigger T. Those skilled in the art will recall that some weapons are designed that any safety mechanism built into the weapon automatically switches from off/safe to on/fire when the weapon is withdrawn from its holster. Further, some weapons are designed to have no safety mechanism at all, so the weapon is always ready to fire.

Firearm F of the present invention incorporates a number of features to assist the officer in dangerous situations.

First, a camera CAM is mounted on the underside of the weapon's frame E beneath the front or muzzle end of the weapon, as shown in FIG. 1. Camera CAM acquires real time video imagery which is transmitted over a bi-directional communications link L1 to the officer's vehicle V or a bi-directional communications link L2 to a central dispatcher location D, or to another designated location. At each location V and D, the imagery is recorded for future use.

Next, firearm F is equipped with a microphone MIC which captures the officer's voice and other sounds and background noises, all in real time. The audio is also transmitted over respective links L1 and L2 to police vehicle V, dispatcher location D, or other designated location.

In FIG. 1, it will be noted that there is also a bi-directional communication link L3 between vehicle V and dispatcher location D. While communications over this third link are not directed from or to firearm F, this link is important because it allows the officer's partner in the vehicle, or an area adjacent the officer's location, and the dispatcher, to communicate directly with each other in order to aid the officer.

Transmission of video and audio is accomplished using a transmitter XMT incorporated in the frame of firearm F. In addition to the transmitter, a receiver RCV is also incorporated in the frame. Receiver RCV includes a speaker K. The transmitter and receiver are equipped with Bluetooth® or other communications protocol which facilitates two-way communications between sites.

While police vehicles V are equipped with a global positioning system GPS, once the officer leaves the vehicle, he may not be readily tracked. For this reason, firearm F is equipped with a GPS unit built into its frame. The unit not only allows the officer's location to be reported to his vehicle and the dispatcher; but, in the unlikely event the officer loses his weapon or it is taken away from him, its location is readily known so that it can be tracked down and recovered.

In the course of the officer's duties, the above described devices are all activated when the officer draws the firearm from its holster L and moves safety switch S to its “on/fire” position.

Finally, all of the above described devices are powered by a battery B mounted in the firearm. Battery B is a lithium or other long term battery having a sufficient capability to power all of the above described devices for long periods of time regardless of the environment (hot, cold, damp, etc.) in which the firearm may be found in the officer's exercise of his duties. Battery B can also be readily replaced if necessary or required.

As shown in FIG. 2, a holster L in which the officer carries his firearm F includes a battery charger BC. When the firearm is holstered, battery charger BC is connected to battery B by a charging line CL incorporated in the firearm's handle H to keep battery B fully charged so none of the devices loses battery power when the firearm is in use.

In view of the above, it will be seen that the several objects and advantages of the present disclosure have been achieved and other advantageous results have been obtained.

Having thus described the invention, what is claimed and desired to be secured by Letters Patent is:

1. A firearm for use by a police officer and other law enforcement personnel comprising:
a frame:
a video camera attached to an underside of the frame at a muzzle end of the firearm;
a microphone mounted to the frame; and,
a transmitter and a receiver mounted on the frame for transmitting video imagery and sound to a police vehicle and/or a police dispatcher and for receiving audio communications therefrom so the police officer carrying the firearm is in constant two-way communications with locations remote from the location of the police officer and the firearm.

2. The firearm of claim 1 having a safety switch, the camera, microphone, transmitter and receiver being activated when the police officer draws the firearm from a holster and moves the safety switch from an “off/safe” to an “on/fire” position.

3. The firearm of claim 1 further including a battery installed in the frame for supplying power to the camera, microphone, transmitter and receiver.

4. The firearm of claim 1 further including a global positioning system (GPS) mounted in the frame for providing the location of the firearm, the GPS also being powered by the battery.

5. The firearm of claim 3 using a Bluetooth® protocol for communications.

6. The firearm of claim 3 further including a holster in which the firearm is carried, the holster including a battery charger which connects to the firearm to charge the battery while the firearm is holstered.
